(19) United States
(12) Patent Application Publication
(10) Pub. No.: US 2020/0097999 A1
(43) Pub. Date: Mar. 26, 2020

(54) INFORMATION PROCESSING APPARATUS AND NON-TRANSITORY COMPUTER READABLE MEDIUM

(71) Applicant: FUJI XEROX CO., LTD., Tokyo (JP)

(72) Inventors: Shotaro MISAWA, Kanagawa (JP); Masahiro SATO, Kanagawa (JP); Tomoki TANIGUCHI, Kanagawa (JP); Tomoko OHKUMA, Kanagawa (JP)

(73) Assignee: FUJI XEROX CO., LTD., TOKYO (JP)

(21) Appl. No.: 16/382,216

(22) Filed: Apr. 12, 2019

(30) Foreign Application Priority Data
Sep. 25, 2018 (JP) 2018-178442

(51) Int. Cl. G06Q 30/02

(52) U.S. Cl. CPC G06Q 30/0246; G06Q 30/0202

(57) ABSTRACT

An information processing apparatus includes a predicting unit that predicts a first transaction count by which a user performs a commercial transaction of an item when an advertisement explaining the item is displayed and a second transaction count by which the user performs the commercial transaction of the item when the advertisement is not displayed, a determination unit that determines a degree of influence that the advertisement has on the commercial transaction of the item from information on the first transaction count and the second transaction count and information on the item, an identifying unit that identifies a combination of an item and an advertisement, the combination having a maximum degree of influence, and a controller that performs control to display the identified combination of the item and the advertisement.

### CROSS-REFERENCE TO RELATED APPLICATIONS

This application is based on and claims priority under 35 USC 119 from Japanese Patent Application No. 2018-178442 filed Sep. 25, 2018.

### BACKGROUND

### (i) Technical Field

The present disclosure relates to an information processing apparatus and a non-transitory computer readable medium.

### (ii) Related Art

Japanese Unexamined Patent Application Publication No. 2013-012168 discloses one technique. In the disclosed technique, a sales promotion activity of a product is performed to increase a sales amount of the product by computing on a per product basis a correlation between sales promotion contents and the sales amount of the product.

Japanese Unexamined Patent Application Publication No. 2010-237923 discloses another technique. In the disclosed technique, sales amounts of products are predicted in accordance with product attributes to categorize the products and an advertisement area is determined from a past advertisement size of a product in accordance with the information on the categorized products.

Japanese Unexamined Patent Application Publication No. 2004-110417 discloses another technique. In the disclosed technique, an advertisement of a product item is posted in response to the sales amount of the product item.

When a catchphrase explaining a product item to be dealt is displayed, the number of transactions of the product item may be increased in comparison with when the catchphrase is displayed. The degree of growth rate of the increase in the transaction count is different depending on the displayed catchphrase and the product item. The degree of growth rate of the increase in the transaction count may possibly difficult to increase depending on a combination of the catchphrase and the product item.

### SUMMARY

Aspects of non-limiting embodiments of the present disclosure relate to providing an information processing apparatus that, when there are multiple combinations of catchphrases and product items are present, identifies a combination of a catchphrase and a product item that results in a higher transaction count of the product item dealt by a user with the catchphrase explaining the product item displayed than with the catchphrase not displayed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus. The information processing apparatus includes a predicting unit that predicts a first transaction count by which a user performs a commercial transaction of an item when an advertisement explaining the item is displayed and a second transaction count by which the user performs the commercial transaction of the item when the advertisement is not displayed, a determination unit that determines a degree of influence that the advertisement has on the commercial transaction of the item from information on the first transaction count and the second transaction count and information on the item, an identifying unit that identifies a combination of an item and an advertisement, the combination having a maximum degree of influence, and a controller that performs control to display the identified combination of the item and the advertisement.

### BRIEF DESCRIPTION OF THE DRAWINGS

Exemplary embodiments of the present disclosure will be described in detail based on the following figures, wherein:

FIG. 1 is a block diagram illustrating a catchphrase proposing apparatus;

FIG. 2 illustrates storage contents of a storage device;

FIG. 3 is a functional block diagram of functions that are implemented when a central processing unit (CPU) executes a catchphrase proposal processing program;

FIGS. 4A through 4C illustrate a machine learning process of an awareness prediction model of the catchphrase proposing apparatus;

FIGS. 5A through 5C illustrate a machine learning process of a preference prediction model of the catchphrase proposing apparatus;

FIGS. 6A through 6C illustrate a machine learning process of a purchasing quantity prediction model of the catchphrase proposing apparatus;

FIG. 7 is a flowchart illustrating a catchphrase proposal process;

FIG. 8 is a functional block diagram of a CPU of a second exemplary embodiment;

FIG. 9 is a flowchart illustrating a catchphrase proposal process of the second exemplary embodiment;

FIG. 10 is a flowchart illustrating a proposal process of a third second exemplary embodiment;

FIG. 11 is a flowchart illustrating a proposal process of a fourth exemplary embodiment; and

FIGS. 12A through 12B illustrate a machine learning process of a comment selection model.

### DETAILED DESCRIPTION

Exemplary embodiments of the disclosure are described in detail with reference to the drawings.

### First Exemplary Embodiment

A transaction count determination apparatus of a first exemplary embodiment is described with reference to the drawings.

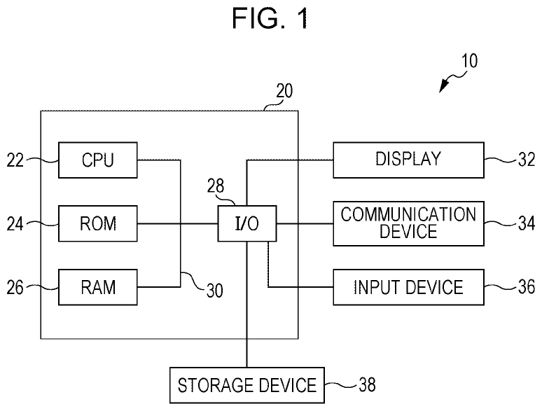

FIG. 1 is a block diagram illustrating a catchphrase proposing apparatus 10. The catchphrase proposing apparatus 10 identifies an item with a purchasing quantity thereof increased with a catchphrase thereof, produces the catchphrase of the identified item, and proposes to a customer the catchphrase that increases the number of purchases.

The catchphrase proposing apparatus 10 is an example of an information processing apparatus of the technique of the disclosure.

Referring to FIG. 1, the catchphrase proposing apparatus 10 includes a computer 20. The computer 20 includes a central processing unit (CPU) 22, a read-only memory (ROM) 24, a random-access memory (RAM) 26, and an input and output (I/O) port 28. The CPU 22, the ROM 24, the RAM 26, and the I/O port 28 are interconnected to each other via a bus 30. The I/O port 28 connects to a display 32, a communication unit 34, an input device 36, and a storage device 38.

The ROM 24 stores a catchphrase proposing program described below. The catchphrase proposing program is an example of an information processing program of the technique of the disclosure.

The communication unit 34 transmits information on the item and the catchphrase to customers. The communication unit 34 may be an email or LINE (registered trademark).

The communication unit 34 is an example of an output unit of the technique of the disclosure.

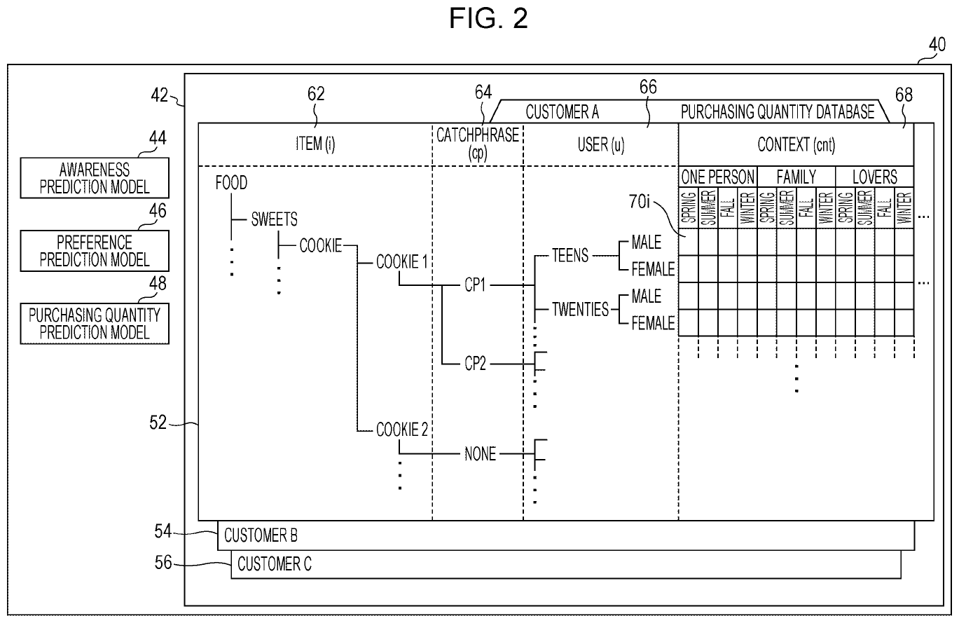

FIG. 2 illustrates storage contents of the storage device 38. A storage region 40 of the storage device 38 stores a purchasing quantity database 42, an awareness prediction model 44, a preference prediction model 46, and a purchasing quantity prediction model 48. The purchasing quantity database 42 includes purchasing quantity prediction models 52, 54, 56, . . . for customers. For example, the purchasing quantity prediction model 52 of a customer A is associated with an item storage region 62, a catchphrase storage region 64, a user information storage region 66, and a context storage region 68. Data of each item to be sold is stored in the item storage region 62. For example, data on specific individual items cookie 1 (crispy) and cookie 2 (soft) in a food-sweets-cookie is stored in the item storage region 62. A catchphrase for an individual item stored in the item storage region 62 is stored in the catchphrase storage region 64. Multiple catchphrases may be stored for a single item in the catchphrase storage region 64. For example, CP1 (highly enjoyable crispy), or CP2 (full flavor of the ingredients) is stored in association with cookie 1. No catchphrase is stored in association with cookie 2.

Data on an individual user is stored in association with each catchphrase in the user information storage region 66. For example, the user information of individual users (customers) indicates one of sets of customers. The sets of users are categorized according to their attributes. For example, the user information may indicate a teenage male, a teenage female, a male in his twenties, a female in her twenties, . . . Teenage males do not represent a single teenage male but represents a set of all teenage males. In place of or in addition to this categorization, information representing the attribute of a specific person. Furthermore, names of individual users, such as a user A, a user B, and a user C may be stored. Information that does not identify a specific user (for example, a member identification (ID)) may be stored. Data of each context may be stored in association with the information on the individual user in the context storage region 68. The content indicates a person with whom a user of interest has purchased and the time of the purchasing of the item. For example, the context specifically indicates the season in which a single person has purchased the item in the spring, the summer, the fall or the winter. The context also specifically indicates the case in which the user has purchased the item together with their family or with their lover. A purchasing quantity storage region 70i is arranged in accordance with each specific context. The purchasing quantity storage region 70i stores data indicating the number of items the user has purchased with or without a catchphrase associating each item. For example, the purchasing quantity storage region 70i indicates that in one person in the spring (specific context) a teenage male (user) has purchased 5 pieces (data) of cookie 1 (item) having CP1 (highly enjoyable crispy (catchphrase)) as the purchasing quantity at a time during a unit time. The unit time may be a week, a month, three months, or the like. The purchasing quantity is a normalized value. Specifically, rather than a single teenage male having purchased cookie 1 associated with CP1 in one person in the spring, the set of all teenage males may now purchase 50 pieces within a week. If the purchasing count of an individual teenage male (corresponding to the number of visits to a shop) is 10 times, the count of 50 is normalized to 5 pieces, and thus 5 pieces are stored as data. More in detail, a user A, a user B, and a user C, each in their teens, may come to the shop five times, three times, and twice within a week, respectively. The user A has purchased 7 pieces each times, a total of 35 pieces within the week, the user B has purchased 3 pieces each time, a total of 9 pieces within the week, and the user C has purchased 3 pieces each time, a total of 6 pieces within the week. Within the week, a total 50 pieces have been purchased, and the value normalized by the purchasing count is 5 pieces.

A purchasing quantity database 54 of a customer B may store, in an item storage region, data of each of items including an electronic apparatus such as an office electronic apparatus (a copying machine, a fax device, a scanner, a multi-function apparatus having a copying function, a fax function, and a scanner function, a personal computer, or a telephone) or a personal electronic apparatus (such as a copying machine, a fax device, a scanner, a multi-function apparatus having a copying function, a fax function, and a scanner function, a personal computer, or a telephone).

Cookie 1 is an example of an “item” of the technique of the disclosure. The catchphrase is an example of an “advertisement” of the technique of the disclosure. The teenage male is an example of a “consumer” of the technique of the disclosure.

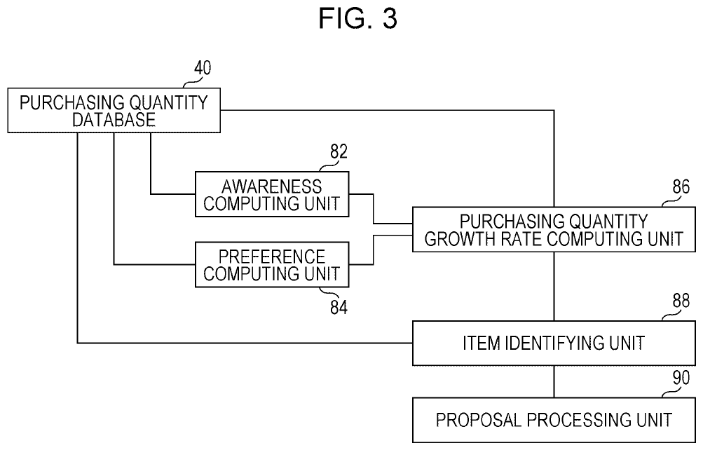

FIG. 3 is a functional block diagram of function blocks that are implemented when the CPU 22 executes a catchphrase proposing program. The functions of the catchphrase proposing program includes an awareness computing function, a preference computing function, a purchasing quantity growth rate computing function, an item identifying function, and a proposal processing function. The CPU 22 executes the catchphrase proposing program having these functions. The CPU 22 thus implements an awareness computing unit 82, a preference computing unit 84, a purchasing quantity growth rate computing unit 86, an item identifying unit 88, and a proposal processing unit 90.

The awareness computing unit 82 computes, in each context, the degree of awareness indicating that each user is aware of a catchphrase of each item. The awareness computing unit 82 computes the degree of awareness by using the awareness prediction model 44 that is determined in advance via machine learning.

The preference computing unit 84 computers the degree of preference indicating how much each user likes the catchphrase in each context. The preference computing unit 84 computers the degree of preference by using the preference prediction model 46 that is determined via machine learning in advance.

The purchasing quantity growth rate computing unit 86 computers the growth rate of a purchasing prediction quantity attributed to the presence of the catchphrase in each user and context. The purchasing quantity growth rate computing unit 86 computers the growth rate of the purchasing quantity by using the current purchasing quantity and the purchasing quantity growth rate that is predicted by using the purchasing quantity prediction model 48 determined via machine learning in advance. The purchasing quantity is the number of items that have been purchased. As described above, the unit time is a week, a month, three months, or the like.

Each of the awareness computing unit 82, the preference computing unit 84, and the purchasing quantity growth rate computing unit 86 is an example of a “predicting unit” of the technique of the disclosure. The purchasing quantity growth rate computing unit 86 and the item identifying unit 88 are respectively examples of a “determination unit” and an “identifying unit” of the technique of the disclosure. The proposal processing unit 90 is an example of an “output processing unit” of the technique of the disclosure.

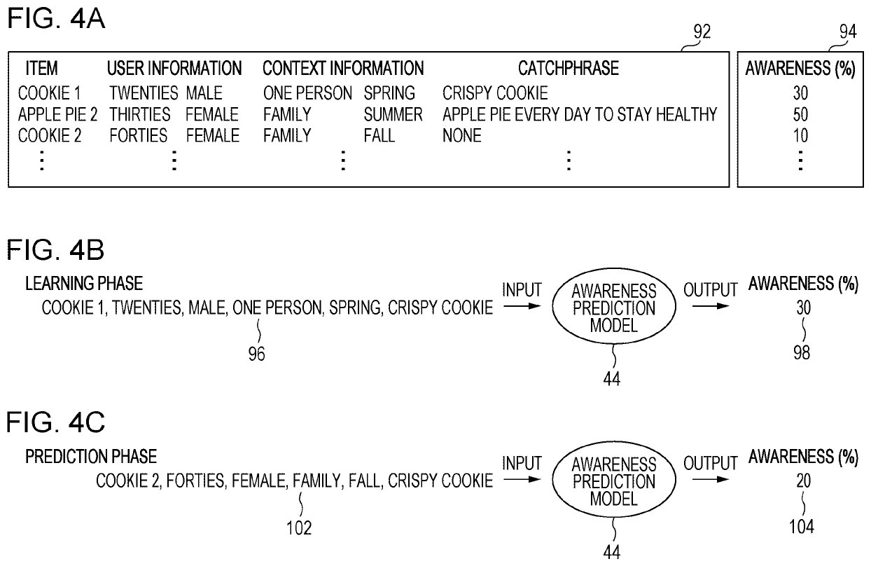

FIGS. 4A through 4C illustrate a process of machine learning of the awareness prediction model 44 in the catchphrase proposing apparatus 10. Referring to FIG. 4A, to perform machine learning of the awareness prediction model 44, the catchphrase proposing apparatus 10 receives input data 92 including multiple sets, each set including information about each item, user information, context information, and catchphrase and correct data 94 about multiple correct answers responsive to the multiple sets of input data.

Each combination of the input data 92 includes the item, the user information, the context information, and the catchphrase. For example, the combination includes cookie 1 as an item, a male in his twenties as the user information, one person in spring as the context information, and “highly enjoyable crispy” as the catchphrase.

The correct data 94 is a correct answer responsive to the set of the input data, namely, the degree of awareness of the catchphrase indicating how much the catchphrase is recognized in the condition determined by the input data.

Specifically, the correct data 94 indicates the awareness indicating how much a single teenage male recognizes “highly enjoyable crispy” when purchasing cookie 1.

The degree of awareness is a difference between a ratio of the number of items actually purchased to the total number of items purchasable in the condition (per unit time) with the catchphrase associated and a ratio of the number of items actually purchased to the total number of items purchasable in the condition with no catchphrase associated. For example, when a male in his twenties purchases cookie 1, the ratio of the number of items to the total number of items purchasable with the catchphrase “highly enjoyable crispy” associated may be 40 percent, and the ratio of the number of items to the total number of items purchasable with no catchphrase associated may be 10 percent. The difference in this case is 30 percent. This is the degree of awareness.

Referring to FIG. 4B, when the set of input data is input, the machine learning of the awareness prediction model 44 is performed such that the awareness prediction model 44 outputs a correct answer 98. For example, if input data 96, namely, cookie 1, twenties, male, one person, spring, and “highly enjoyable crispy” (indicating the condition that a male in his twenties purchases cookie 1 with the catchphrase “highly enjoyable crispy” in the spring) is input, the awareness prediction model 44 trained such that the correct answer of 30 percent is output. The machine learning is performed on each set of input data.

Referring to FIG. 4C, the awareness prediction model 44 outputs the correct answer (degree of awareness) in response to each set of other input data. For example, if cookie 2, forties, female, family, fall, and “highly enjoyable crispy” (indicating the condition that a female in her forties with her family purchases cookie 2 with the catchphrase “highly enjoyable crispy” in the fall) is input, the awareness prediction model 44 outputs 20 percent as the correct answer.

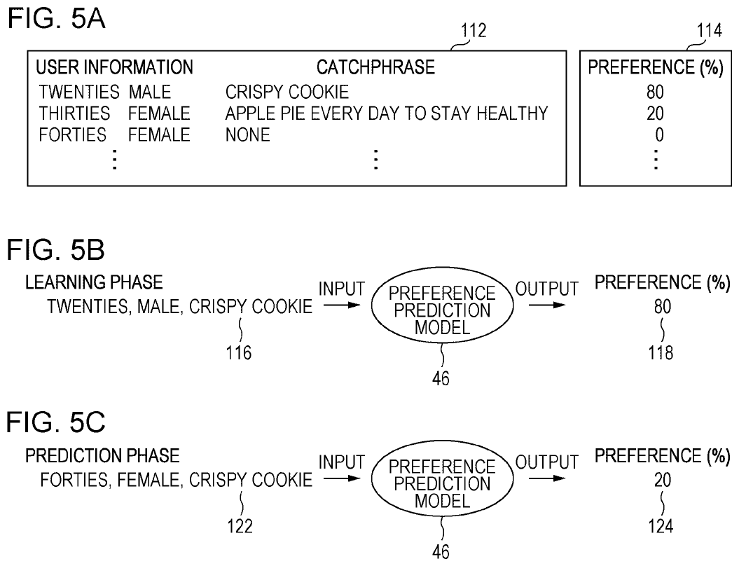

FIGS. 5A through 5C illustrate the machine learning process of the preference prediction model 46 in the catchphrase proposing apparatus 10. Referring to FIG. 5A, to perform machine learning of the preference prediction model 46, the catchphrase proposing apparatus 10 receives input data 92 including multiple sets, each set including the user information and catchphrase and correct data 114 about multiple correct answers responsive to the multiple sets of input data.

Each set of input data 112 includes the user information and the catchphrase. For example, the set of the input data 112 may include a male in his twenties as the user information and highly enjoyable crispy as the catchphrase.

The correct data 114 is a correct answer responsive to each set of input data, namely, the degree of preference for the catchphrase indicating how much the catchphrase in the condition determined by the input data is desired. Specifically, the correct data 114 is the degree of preference indicating how much the male in his twenties likes the catchphrase “highly enjoyable crispy”.

The degree of preference is a difference between a ratio of the number of items actually purchased to the total number of items purchasable (within the unit time) in the condition with the catchphrase associated and a ratio of the number of items actually purchased to the total number of items purchasable (within the unit time) in the condition with no catchphrase associated. For example, when a male in his twenties purchases cookie 1, the ratio of the number of items to the total number of items purchasable with the catchphrase “highly enjoyable crispy” associated may be 90 percent, and the ratio of the number of items to the total number of items purchasable with no catchphrase associated may be 10 percent. The difference in this case is 80 percent. This is the degree of preference.

Referring to FIG. 5B, when the set of input data is input, the machine learning of the preference prediction model 46 is performed such that the preference prediction model 46 outputs a correct answer 118. For example, if input data 116 including twenties, male, one person, and “highly enjoyable crispy” (indicating the condition that is determined by a male in his twenties and the catchphrase “highly enjoyable crispy”) is input, the preference prediction model 46 is trained such that the correct answer of 80 percent is output. The machine learning is performed on each set of input data.

Referring to FIG. 5C, the preference prediction model 46 outputs the correct answer (the degree of awareness) in response to each set of other input data. For example, if forties, female, and “highly enjoyable crispy” (indicating the condition that is determined by a female in her forties with the catchphrase “highly enjoyable crispy”) is input, the preference prediction model 46 outputs 20 percent as the correct answer.

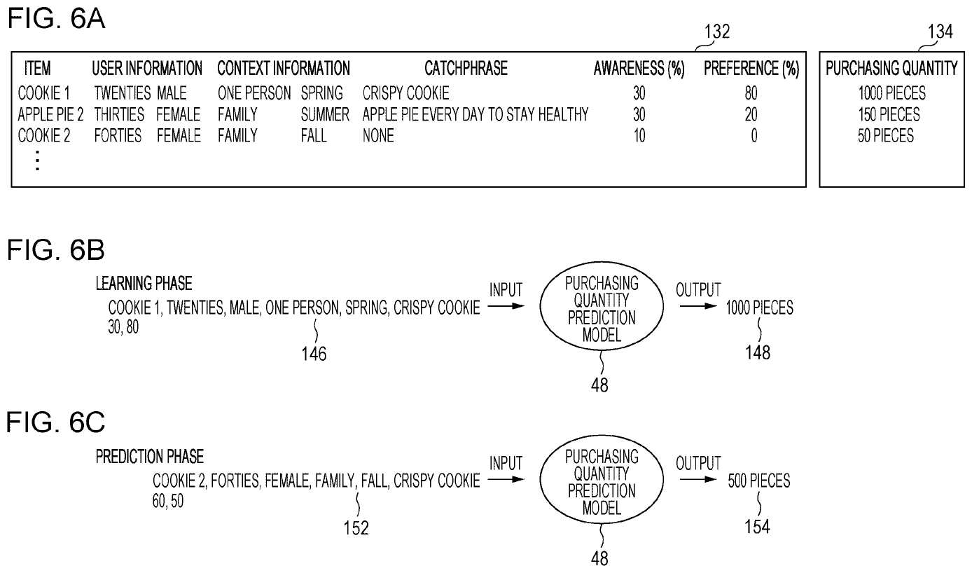

FIGS. 6A through 6C illustrate a process of machine learning of the purchasing quantity prediction model 48 in the catchphrase proposing apparatus 10. Referring to FIG. 6A, to perform machine learning of the purchasing quantity prediction model 48, the catchphrase proposing apparatus 10 receives input data 132 including multiple sets, each set including information about each item, user information, context information, catchphrase, the degree of awareness, and the degree of preference and correct data 134 about multiple correct answers responsive to the multiple sets of input data.

Each combination of the input data 132 includes each item, the user information, the context information, the catchphrase, the degree of awareness, and the degree of preference. For example, the combination may include cookie 1 as the item, a male in his twenties as the user information, one person in spring as the context information, and “highly enjoyable crispy” as the catchphrase, 30 percent as the degree of awareness, and 80 percent as the degree of preference.

The correct data 134 is a correct answer responsive to the set of the input data, namely, a prediction purchasing quantity (per unit time) of the item with the catchphrase in the condition determined by the input data. Specifically, the correct data 134 indicates the predicted purchasing quantity of cookie 1 with “highly enjoyable crispy” by a male in his twenties alone in the spring.

The input data 132 accounts for the degree of awareness and the degree of preference. By accounting for the degree of awareness and the degree of preference, the purchasing quantity prediction model 48 predicts the purchasing quantity of the item with the catchphrase in the condition determined by the input data.

Referring to FIG. 6B, when the set of input data is input, the purchasing quantity prediction model 48 performs machine learning to output a correct answer 148. For example, if input data 146, namely, cookie 1, twenties, male, one person, spring, “highly enjoyable crispy,” 30 percent, and 80 percent (indicating the condition that a male in his twenties alone purchases cookie 1 with the catchphrase “highly enjoyable crispy” in the spring, and the degree of awareness and the degree of preference of the catchphrase are respectively 30 percent and 80 percent) is input, the purchasing quantity prediction model 48 is trained such that the correct answer of 1000 pieces is output. The machine learning is performed on each set of input data.

Referring to FIG. 6C, the purchasing quantity prediction model 48 outputs a correct answer (degree of awareness) 154 in response to each set of other input data. For example, if input data 152, namely, cookie 2, forties, female, family, fall, “highly enjoyable crispy”, 60 percent, and 50 percent (indicating the condition that a female in her forties with her family purchases cookie 2 with “highly enjoyable crispy” and the degree of awareness and the degree of preference of the catchphrase are respectively 60 percent and 50 percent) is input, the purchasing quantity prediction model 48 outputs 500 pieces as the correct answer.

If the number of purchases is 50 pieces with no catchphrase, the purchasing quantity is predicted to increase by 450 pieces. The growth rate (the ratio of the purchasing quantity with the catchphrase (500 pieces) to the purchasing quantity without the catchphrase (50 pieces)) is computed to be 10 times.

The machine learning of the purchasing quantity prediction model 48 is not limited to the method described above, but may be performed as below. The purchasing quantities depending the presence or absence of the catchphrase may be sorted according to the attribute of each item and used as the input data.

Specifically, as illustrated in FIGS. 6A through 6C, the item is cookie 1. Data of attributes of the item may be organized as the input data of the item as follows: cookie, soft, and a subpart of three pieces or cookie, crispy, and a subpart of one piece.

If distributed representation (the contents of an item are represented by a vector) expressing an item is acquired in advance in other model, the other information may be dispensed with.

The purchasing quantity prediction model 48 performs machine learning independent of the machine learning of the awareness prediction model 44 and the preference prediction model 46. The technique of the disclosure is not limited to this method. The purchasing quantity prediction model 48 may perform the machine learning with a neural network model by using the machine learning of the awareness prediction model 44 and the preference prediction model 46.

The degree of awareness is appropriately computed by inputting an item, and the resulting value is input to the purchasing quantity prediction model 48. A model used to predict the purchasing quantity is thus produced. When the purchasing quantity prediction model 48 is trained, the degree of awareness that is able to predict the purchasing quantity more accurately is determined. For example, although the awareness prediction model 44 has output a value of 30 percent, a value of 50 percent in place of the value of 30 percent is input to the purchasing quantity prediction model 48. The purchasing quantity is thus more accurate. The machine learning of the purchasing quantity prediction model 48 is thus performed in the machine learning of the awareness prediction model 44 and the preference prediction model 46.

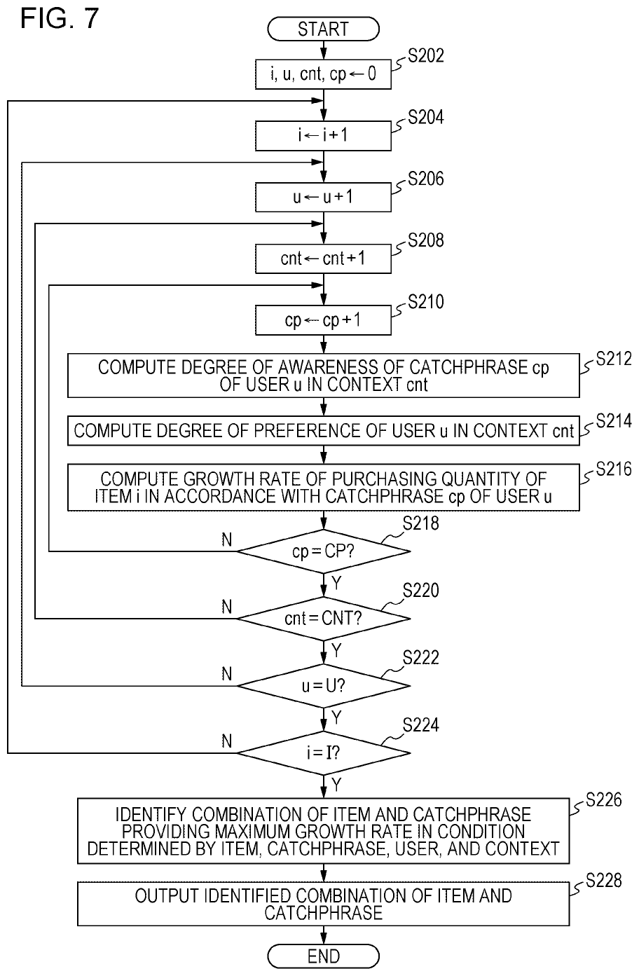

FIG. 7 illustrates a flowchart of the catchphrase proposing process that is performed when the CPU 22 executes the catchphrase proposing program stored on the ROM 24.

The catchphrase proposing program is executed on a per customer (user) basis. In step S202 of FIG. 7, the awareness computing unit 82 sets a variable i, a variable u, a variable cnt, and a variable cp to zero. The variable i identifies an item stored on the item storage region 62 of the purchasing quantity database 52 for a customer A on the purchasing quantity database 42. The variable u identifies a user whose information is stored on the user information storage region 66 in association with the item i identified by the variable i. Specifically, variables u=1, 2, 3, . . . identify males in their teens (all), females in their teens (all), males in their twenties (all) . . . If information representing the attributes of a particular individual user (such as a male in his twenties), information on individual users (user A, user B, user C, . . . ), or information not identifying a particular individual user (such as a member ID) is stored, the variable u identifies each of these pieces of information. The variable cnt identifies each context stored on the context storage region 68 in response to the variable i. The variable cp identifies a catchphrase other than the catchphrases stored on the catchphrase storage region 64 in response to the variable i. As a first example of the catchphrase, the range of catchphrases other than the catchphrases stored on the catchphrase storage region 64 in response to the variable i may be determined by identifying the catchphrase of another item that falls within the same type of the item i. For example, if the item i is cookie 1, the catchphrase of cookie 2 different from cookie 1 but falling within the same type as cookie 1 is identified. As a second example of the catchphrase, each catchphrase of an item of a different type that is purchased at the same time when the item i is purchased may be identified. As a third example of the catchphrase, the items of the first example and the second example may be identified. The purchasing quantity databases 52, 54, 56, . . . for each of the customers of the purchasing quantity database 42 are associated with other items that are purchased at the same time.

In step S204, the awareness computing unit 82 increments the variable i by 1. In step S206, the awareness computing unit 82 increments the variable u by 1. In step S208, the awareness computing unit 82 increments the variable cnt by 1, and in step S210 the awareness computing unit 82 increments the variable cp by 1.

In step S212, the awareness computing unit 82 computes in accordance with the awareness prediction model 44 the degree of awareness of the catchphrase cp identified by the variable cp in the user u identified by the variable u and the context cnt identified by the variable cnt.

In step S214, the preference computing unit 84 computes the degree of preference of the catchphrase cp of the user u in the user u and the context cnt by using the preference prediction model 46.

In step S216, the purchasing quantity growth rate computing unit 86 computes a prediction purchasing quantity of the item i in accordance with the catchphrase cp in the user u and the context cnt by using data about the user u, the context cnt, and the item i, the degree of awareness computed in step S212, the degree of preference computed in step S214, and the purchasing quantity prediction model 48.

The purchasing quantity growth rate computing unit 86 computes the growth rate by using the prediction purchasing quantity, and a prior purchasing quantity determined by the item i, the catchphrase cp, the user u, and the context cnt.

If the prior purchasing quantity determined by the item i, the catchphrase cp, the user u, and the context cnt is 40 pieces and the prediction purchasing quantity is 80 pieces, the purchasing quantity is increased by 40 pieces in accordance with the catchphrase cp. The growth rate is twice.

In step S218, the awareness computing unit 82 determines whether the variable cp is equal to a total number CP of catchphrases. If the awareness computing unit 82 determines that the variable cp is not equal to the total number CP of catchphrases, the catchphrase proposing process returns to step S210 to perform the loop of steps S210 through S218. If the awareness computing unit 82 determines that the variable cp is equal to the total number CP of catchphrases, the awareness computing unit 82 determines whether the variable cnt is equal to a total number CNT of contexts. If the awareness computing unit 82 determines that the variable cp is not equal to the total number CNT of catchphrases, the catchphrase proposing process returns to step S208 and executes the loop of steps S208 through S220.

If the awareness computing unit 82 determines that the variable cnt is equal to the total number CNT of catchphrases, the awareness computing unit 82 determines in step S222 whether the variable u is equal to a total number U of users. If the awareness computing unit 82 determines that the variable u is not equal to the total number U of users, the catchphrase proposing process returns to step S206 and repeats the loop of steps S206 through S222.

If the awareness computing unit 82 determines that the variable u is equal to the total number U of users, the catchphrase proposing process determines in step S224 whether the variable i is equal to a total number I. If the catchphrase proposing process determines in step S224 that the variable i is not equal to a total number I, the catchphrase proposing process returns to step S204 and repeats the loop of steps S204 through S224.

If the catchphrase proposing process determines in step S224 that the variable i is equal to the total number I, the growth rate in the prediction purchasing quantity in the condition determined by the item, the catchphrase, the user, and the context is computed.

In step S226, the item identifying unit 88 identifies a combination of an item and a catchphrase resulting in a maximum growth rate in the condition that is determined by the item, the catchphrase, the user, and the context. The item identifying unit 88 may identify multiple combinations of items and catchphrases satisfying a predetermined threshold value of the growth rate (for example, a growth rate higher than 1).

In step S228, the proposal processing unit 90 outputs the combination of the item and the catchphrase identified as having a maximum growth rate. The proposal processing unit 90 may output the multiple combinations of the items and the catchphrases satisfying the threshold value of the growth rate (for example, the catchphrase resulting in the growth rate threshold value higher than 1).

The output operation in step S228 is performed by displaying the combination of the item and catchphrase obtained on the display 32.

If the catchphrase proposing process is performed in accordance with the purchasing quantity database for a customer A, a proposal to produce a catchphrase for an item identified as having a growth rate higher than 1 may be made to the customer A, and a catchphrase causing a growth rate higher than 1 may be transmitted to the customer A (via an email or LINE). Contents of the condition resulting in a growth rate higher than 1 may be transmitted to the customer A. Also, the proposal to produce the catchphrase, the catchphrase resulting in the growth rate higher than 1, and the contents of the condition causing a growth rate higher than 1 may be printed on a paper sheet via a printer. The printed paper sheet may then be mailed to the customer A. Alternatively, the proposal to produce the catchphrase, the catchphrase resulting in the growth rate higher than 1, and the contents of the condition causing the growth rate higher than 1 may be verbally delivered to the customer in direct consultation or in person.

In the first exemplary embodiment described above, on a per customer basis, the growth rate of the purchasing quantity caused by the catchphrase in each condition is computed. An item having a growth rate higher than 1 is identified. The proposal to produce a catchphrase for the identified item is made and a catchphrase causing a growth rate higher than 1 is output.

In accordance with the first exemplary embodiment, the growth rate of the purchasing quantity depending on the catchphrase is computed to predict the purchasing quantity. In this operation, the degree of awareness and the degree of preference of the catchphrase are accounted for, and an item having a growth rate higher than 1 may be identified at a higher accuracy level.

In accordance with the first exemplary embodiment, the awareness prediction model obtained via machine learning is used to compute the degree of awareness of the catchphrase. The degree of awareness is thus computed at a higher accuracy level. In accordance with the first exemplary embodiment, the preference prediction model obtained via machine learning is used to compute the degree of preference for the catchphrase. The degree of preference is thus computed at a higher accuracy level. In accordance with the first exemplary embodiment, the purchasing quantity prediction model obtained via machine learning is used to compute the purchasing quantity. The purchasing quantity is thus computed at a higher accuracy level.

In accordance with the first exemplary embodiment, the item, the user information, the context information, and the catchphrase are used as factors that determine the degree of awareness. In another process described below, the degree of awareness is determined by at least the user information and information on the presence or absence of the catchphrase. In addition, the information in the item or the context information may be accounted for.

In accordance with the first exemplary embodiment, the item, the user information, the context information, the catchphrase, the degree of awareness, and the degree of preference are used as factors that determine the purchasing quantity. In another process described below, the purchasing quantity is determined by the presence or absence of at least the information on the item and the presence or absence of the catchphrase. At least a subpart of the factors including the user information, the context information, the catchphrase, the degree of awareness, and the degree of preference may be used instead of using all the factors.

In step S228, the proposal to produce the catchphrase of the item identified as having a growth rate higher than 1 and the catchphrase causing a growth rate higher than 1 are output (reported) to the customer. In addition to or in place of the output operation, at least one of the growth rate, the prediction purchasing quantity, and a benefit is output.

In accordance with the first exemplary embodiment, the growth rate of the prediction purchasing quantity of the item is determined in view of the user, the context, the degree of awareness, the degree of preference. The disclosure is not limited to this operation.

Instead of accounting for all of the user, the context, the degree of awareness, and the degree of preference, the growth rate of the prediction purchasing quantity of the item is computed by not accounting for at least one of these factors.

The growth rate of the prediction purchasing quantity of the item may be computed by accounting for the following factors in addition to or in place of the degree of preference and the degree of awareness. The factors may include at least one of a degree of catchphrase influence of the item, an agreement rate of the context (context agreement rate), and a content agreement of the catchphrase.

The degree of catchphrase influence of the item is a score indicating “the effectiveness of the catchphrase on the item”.

The degree of catchphrase influence of the item is predicted based on the attribute (category) of the item and the effect of the item. The purchasing quantity (or an amount sold) of an item (with the user and context neglected) is computed with or without the catchphrase, and a difference therebetween is a target value for prediction. The contents of the catchphrase may be further accounted for.

The agreement rate of the context is a score indicating how much the catchphrase agrees with the context. The score is computed based on the combination of the catchphrase and the context. Two inputs, namely, the catchphrase and the context are entered. The target value may be a ratio of a target context to the purchasing quantity of the same catchphrase (an amount sold). For example, if 80 pieces are purchased in the summer, 20 pieces in the winter, 10 pieces in the spring, and 100 pieces in the fall with “seasonal food in fall” as a catchphrase, the agreement rate of the summer with respect to the catchphrase is 80/210.

The content agreement of the catchphrase (catchphrase content agreement) is a score indicating how much the catchphrase is appropriate for the corresponding item. For example, the catchphrase “Apple pie every day to stay health” is not appropriate for cookie. The catchphrase content agreement may be computed by using a catchphrase content agreement computing model. The catchphrase content agreement rate computing model may be trained in advance by using the item, the catchphrase, and the score indicating how much the catchphrase is appropriate for the item.

The degree of awareness, the degree of preference, the catchphrase influence of item, the agreement rate of context, and the agreement rate of the catchphrase content are examples of an article of the technique of the disclosure.

### Second Exemplary Embodiment

A second exemplary embodiment is described below. The second exemplary embodiment is substantially identical in configuration to the first exemplary embodiment. The discussion of elements identical to those of the first exemplary embodiment are omitted herein. The following discussion focuses on a difference between the first and second exemplary embodiments.

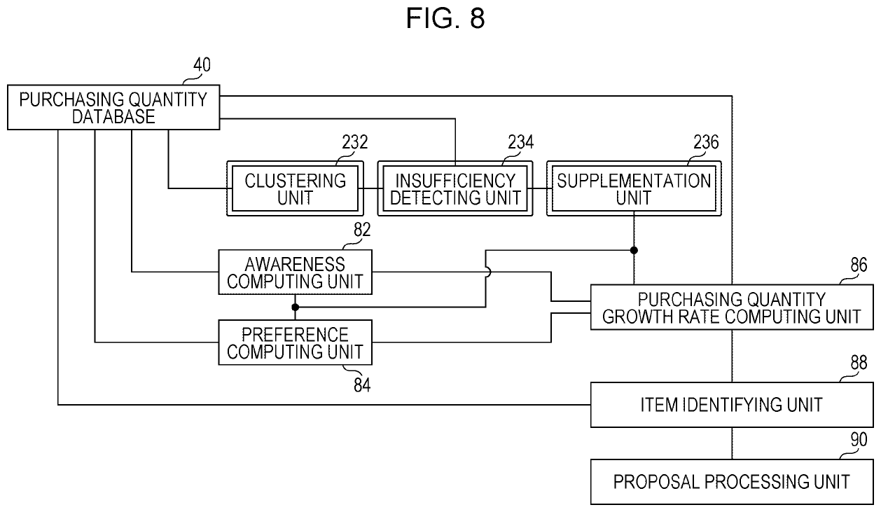

FIG. 8 is a functional block diagram illustrating of the CPU 22 of a second exemplary embodiment. The functionality of the CPU 22 is different from the one in the first exemplary embodiment in that the functionality of the CPU 22 further includes a clustering unit 232, an insufficiency detecting unit 234, and a supplementation unit 236. The clustering unit 232 clusters the catchphrases of the item into a predetermined value, for example, three clusters. The insufficiency detecting unit 234 detects a cluster that lacks an item. The supplementation unit 236 supplements an insufficient cluster. The supplementation unit 236 supplements insufficient clusters, for example, with the catchphrases of other items (such as cookie 2, cookie 3, . . . ) of the same type (such as cookie) and the catchphrases of other items (such as apple pie 1, apple pie 2, apple pie 3, . . . ) that are purchased at the same opportunity.

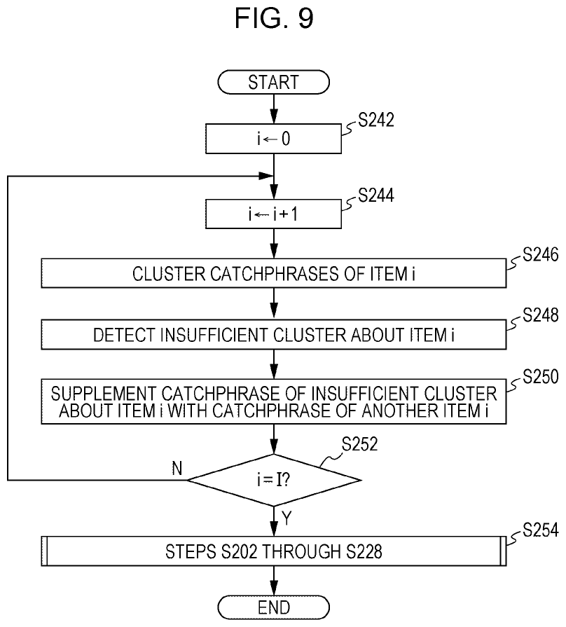

FIG. 9 is a flowchart illustrating the catchphrase proposing process of the second exemplary embodiment.

In step S242 in FIG. 9, the clustering unit 232 sets the variable i to 0, and in step S244 the clustering unit 232 increments the variable i by 1.

In step S246, the clustering unit 232 clusters the catchphrases of the item i identified by the variable i into a predetermined value.

In step S248, the insufficiency detecting unit 234 detects a cluster lacking the item

In step S250, the supplementation unit 236 supplements a catchphrase of another item as a catchphrase of the cluster with reference to the item i. Specifically, as described above, the supplementation unit 236 supplements the catchphrase of another item of the same type, and/or the catchphrases of another item that are purchased at the same opportunity.

In step S252, the clustering unit 232 determines whether the variable i is equal to a total number I of the items. If the clustering unit 232 determines whether the variable i is not equal to the total number I of the items, the catchphrase proposing process returns to step S244 to repeat the loop of steps S244 through S255.

If the clustering unit 232 determines that the variable i is equal to the total number I of the items, the catchphrase proposing process performs in step S254 the operations in steps S202 through S228 of FIG. 7. The variable cp identifies a supplemented catchphrase.

In accordance with the second exemplary embodiment, the catchphrases of the items are clustered. If an insufficient cluster is detected, a catchphrase of another item of the same type or a catchphrase of another item purchased at the same opportunity is supplemented. After the catchphrase is supplemented, an item having a growth rate higher than 1 is identified by accounting for the supplemented catchphrase. More catchphrases growth rate higher than 1 may be provided, leading to expanding the contents of the proposal.

The second exemplary embodiment may provide the same benefits as those of the first exemplary embodiment.

### Third Exemplary Embodiment

A third embodiment is described below. The third exemplary embodiment is substantially identical in configuration to the first exemplary embodiment. Elements in the third exemplary embodiment identical to those of the first exemplary embodiment are designated with the same reference numerals and the following discussion focuses on the difference therebetween.

The function blocks of the CPU 22 of the third exemplary embodiment do not include the awareness computing unit 82 and the preference computing unit 84, and the purchasing quantity growth rate computing unit 86 reads data from the purchasing quantity storage region 40.

The purchasing quantity prediction model of the third exemplary embodiment is used to predict a prediction purchasing quantity if the item is associated with the catchphrase (the contents of the catchphrase do not matter). The purchasing quantity prediction model of the third exemplary embodiment is trained to predict the prediction purchasing quantity with the item associated with the catchphrase (the contents of the catchphrase do not matter) from the purchasing quantity when data of the item and the item are associated with the catchphrase (the contents of the catchphrase do not matter).

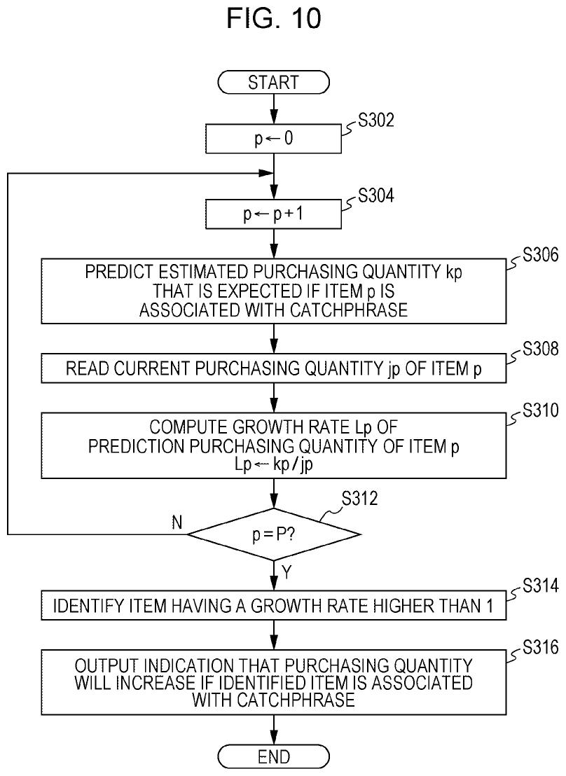

FIG. 10 is a flowchart illustrating a proposal process of the third exemplary embodiment.

In step S302, the purchasing quantity growth rate computing unit 86 initializes to 0 a variable p identifying an item stored on the storage region 40 but not associated with a catchphrase. In step S304, the purchasing quantity growth rate computing unit 86 increments the variable p by 1.

In step S306, using the purchasing quantity prediction model, the purchasing quantity growth rate computing unit 86 predicts a prediction purchasing quantity kp with an item P associated with the catchphrase (the contents do not matter).

In step S308, the purchasing quantity growth rate computing unit 86 reads a current purchasing quantity jp of the item p. Specifically, the purchasing quantity growth rate computing unit 86 reads the purchasing quantity of the item p stored on an individual purchasing quantity storage region corresponding to the item p, and computes the sum.

In step S310, the purchasing quantity growth rate computing unit 86 computes a growth rate Lp of the prediction purchasing quantity of the item P in accordance with Lp←kp/jp.

In step S312, the purchasing quantity growth rate computing unit 86 determines whether the variable p is equal to a total number P of items stored on the storage region 40 but not associated with a catchphrase. If the purchasing quantity growth rate computing unit 86 determines that the variable p is not equal to the total number P of items, the proposal process returns to step S304 and repeats the loop of steps S304 through S312.

If the purchasing quantity growth rate computing unit 86 determines that the variable p is equal to the total number P of items, the item identifying unit 88 identifies an item having a growth rate higher than 1 in step S314. In step S316, the proposal processing unit 90 outputs to a customer an indication that the purchasing quantity will increase if the identified item is associated with the catchphrase (identical to step S228).

In accordance with the third exemplary embodiment, the item with the purchasing quantity thereof increasing with the item associated with the catchphrase is identified, and an indication that the purchasing quantity will increase if the identified catchphrase is associated with the catchphrase is output (notified) to the customer.

The third exemplary embodiment is not limited to identifying the item whose purchasing quantity increases with the item associated with the catchphrase, and may include the following operations.

In a first operation, the item with the purchasing quantity thereof increasing with the item associated with the catchphrase is identified according to the attribute of the item (a category such as a type of the item). An indication that the purchasing quantity will increase if the attribute of the identified item is associated with the catchphrase is output (notified) to the customer.

In a second operation, an insufficient cluster is detected with reference to the catchphrases of the item by executing the operations in steps S242 through S252 of the second exemplary embodiment in FIG. 9. Catchphrases are supplemented to the insufficient cluster. The cluster may not be a detailed cluster but may be a broader cluster. For example, the broader clusters may include an easy cooking cluster, a nice ingredient cluster, and a bargain cluster.

The catchphrase is supplemented to the insufficient cluster of the items by executing the operations in steps S242 through S252. The operations in steps S302 through S316 of the third exemplary embodiment is performed on the items. If the item having the catchphrase supplemented to the insufficient cluster thereof is associated with the catchphrase, the purchasing quantity of the item will increase. The item that may have the increased purchasing quantity is thus identified. An indication that the purchasing quantity will increase if the identified item is associated with the catchphrase is output (notified) to the customer.

### Fourth Exemplary Embodiment

A fourth exemplary embodiment is described. The fourth exemplary embodiment is substantially identical to the first exemplary embodiment. Elements in the first exemplary embodiment identical to those in the first exemplary embodiment are designated with the same reference numerals, and the discussion thereof is omitted herein. The following discussion focuses on the difference therebetween.

A purchasing quantity storage region 70i of the storage region 40 of the fourth exemplary embodiment in FIG. 2 stores in addition to the purchasing quantity, the degree of awareness that is computed in advance in the condition determined by the item, the catchphrase, and the user. The purchasing quantity storage region 70i also stores the degree of preference that is computed in advance in the condition determined by the catchphrase and the user.

The CPU 22 of the fourth exemplary embodiment is identical in functional block to the CPU 22 of the third exemplary embodiment.

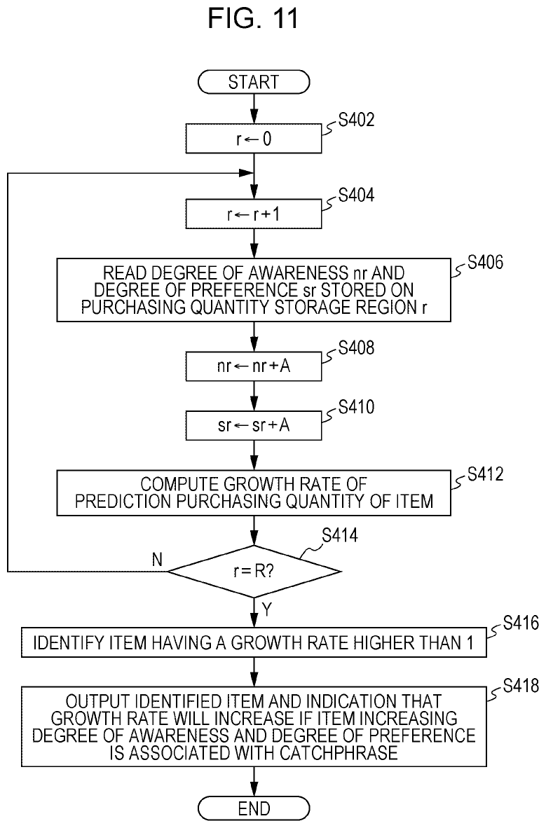

FIG. 11 is a flowchart illustrating a proposal process of the fourth exemplary embodiment.

In step S402, the purchasing quantity growth rate computing unit 86 initialize to 0 a variable r that identifies a purchasing quantity storage region that is determined by the item, the catchphrase, the user, and the context. In step S404, the purchasing quantity growth rate computing unit 86 increments the variable r by 1.

In step S406, the purchasing quantity growth rate computing unit 86 reads the degree of awareness nr and the degree of preference sr stored on the purchasing quantity storage region r. In step S408, the purchasing quantity growth rate computing unit 86 increases the degree of awareness nr by A percent (for example, 10 percent). In step S410, the purchasing quantity growth rate computing unit 86 increases the degree of preference sr by A percent. A is not limited to 10 percent, and may be 15 or 20 percent. In this operation, one of the degree of awareness nr and the degree of preference sr may be increased more than the other.

In step S412, the purchasing quantity growth rate computing unit 86 computes the growth rate of the prediction purchasing quantity of the item corresponding to the variable r in accordance with the increased degree of awareness nr and degree of preference sr and the purchasing quantity prediction model 48.

In step S414, the purchasing quantity growth rate computing unit 86 determines whether the variable r is equal to a total number R in the purchasing quantity storage region. If the purchasing quantity growth rate computing unit 86 determines that the variable r is not equal to the total number R, the proposal process returns to step S404 to repeat the loop of steps S404 through S414.

If the purchasing quantity growth rate computing unit 86 determines that the variable r is equal to the total number R, the item identifying unit 88 identifies an item having a growth rate higher than 1 in step S416. In step S418, the proposal processing unit 90 outputs information on the item together with an indication that the purchasing quantity will increase if the item is associated with the catchphrase able to increases the degree of awareness and the degree of preference (identical to step S228).

The fourth exemplary embodiment identifies the item whose purchasing quantity will increase if the item is associated with the catchphrase able to increase the degree of awareness and degree of preference. The proposal processing unit 90 informs the customer of the identified item and informs the customer that the purchasing quantity will increase if the item is associated with the catchphrase able to increase the degree of awareness and degree of preference.

The fourth exemplary embodiment is not limited to identifying the item whose purchasing quantity will increase if the item is associated with the catchphrase able to increase the degree of awareness and the degree of preference. The fourth exemplary embodiment may be implemented by identifying the item whose purchasing quantity will increase if the item is associated with the catchphrase able to increase one of the degree of awareness and the degree of preference. The proposal processing unit 90 informs the customer of the identified item and informs the customer that the purchasing quantity will increase if the item is associated with the catchphrase able to increase one of the degree of awareness and degree of preference.

The fourth exemplary embodiment may also be implemented by identifying an item whose purchasing quantity increases if the item is associated with the catchphrase that is able to increase the context agreement rate together with or in place of at least one of the degree of awareness and the degree of preference. The proposal processing unit 90 informs the customer of the identified item and informs the customer that the purchasing quantity will increase if the item is associated with the catchphrase able to increase the degree of awareness and degree of preference.

### Modifications

Modifications of the technique of the disclosure are described below. The configuration and operation of each of the modification are substantially identical to those of the first exemplary embodiment or the second exemplary embodiment, and only the difference therebetween is described below.

### First Modification

A first modification is described below. In addition to the operation of the first exemplary embodiment, a user review sentence (user comment), such as “It tastes like pudding,” “The children ate them,” or “Good for you on a diet,” may be identified with respect to each item, and then the catchphrase proposal process in FIG. 7 may be performed.

The review sentence may include a user review sentence on an item, a similar item, and another item in the same category. The review sentence may be obtained via a web service, such as a word-of-mouth function, and stored on the purchasing quantity databases 52, 54, 56, . . . of the customers. When the user review sentences are stored on the purchasing quantity databases 52, 54, 56, . . . , the review sentences are not directly stored but stored in a difference expression without changing the meaning thereof.

In accordance with the first modification, the review sentence is used as a catchphrase. The catchphrases increasing the growth rate to higher than 1 may be increased, and the proposal is expanded.

### Second Modification

In accordance with the first modification, the review sentence, such as “It tastes like pudding,” “Children ate them,” or “Good for you on a diet,” is identified. The purchasing quantity prediction model is not trained in view of the review sentence.

In accordance with a second modification, the purchasing quantity prediction model is trained in view of the review sentence, and the variable cp is identified by using not only a catchphrase but also a review sentence as a catchphrase.

In accordance with the second modification, the purchasing quantity prediction model is trained in view of the review sentence. The number of catchphrases increasing the growth rate to higher than 1 is increased. The number of catchphrases is increased at a higher accuracy level. The contents of the proposal are thus expanded at a higher accuracy level.

### Third Modification

In accordance with the first and second modifications, a review sentence obtained via the web service, such as a word-of-mouth function, is directly used.

In accordance with a third modification, a review sentence selected by a review sentence selection model obtained via machine learning advance is used.

A machine learning method of the review sentence selection model is described below.

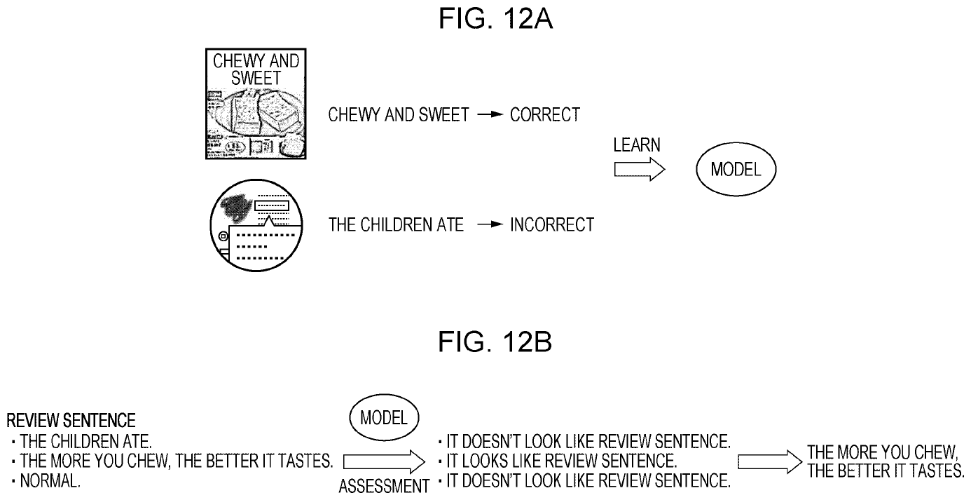

FIG. 12 illustrates the machine learning method of the review sentence selection model. Referring to FIG. 12, the machine learning method of the review sentence selection model learns the review sentence selection model with the review sentence set to be incorrect and the catchphrase set to be correct.

If a review sentence obtained via the web service, such as a word-of-mouth function, is input to the review sentence selection model thus machine-learned, assessment results appears, reading it looks like a review sentence or it doesn't look like a review sentence as illustrated in FIG. 12. The review sentence that is assessed as it looks like a review sentence is used as described above.

The review sentence selection model is automatically trained via machine learning, in other words, the acquired review sentence is determined whether it looks like a catchphrase, specifically is a positive opinion, includes a smaller number of words, and leads to a growth rate of higher than 1.

In accordance with the third modification, a larger number of catchphrases leading to a growth rate of higher than 1 may be obtained, and the contents of the proposal may be expanded.

### Other Modifications

Each of the exemplary embodiments and the modifications uses the awareness prediction model, the preference prediction model, and the purchasing quantity prediction model. The technique of the disclosure is not limited to this method. For example, statistical information may be used without using at least of these models.

If a difference between results of the purchasing quantities of a given item depending on whether the catchphrase is present or not is relatively smaller, the degree of awareness is considered to be smaller. The difference between the results may be converted into a value (for example, a value between 0 and 1), and the value may be used as the degree of awareness of the item.

In the modifications described above, the purchasing quantity prediction model is used. The technique of the disclosure is not limited to this method. A growth rate prediction model may be used.

The growth rate prediction model computes a growth rate of the prediction purchasing quantity of an item with respect to the current purchasing quantity when the item is associated with the catchphrase.

By using the item, the catchphrase, and the growth rate of the prediction purchasing quantity of the item with respect to the current purchasing quantity, the growth rate prediction model is trained such that the growth rate of the prediction purchasing quantity of the item with respect to the current purchasing quantity is computed when the item is associated with the catchphrase.

If the growth rate of the prediction purchasing quantity of the item with respect to the current purchasing quantity is higher (lower) than 1, an increase (decrease) in the number of transactions of the item is detected when an advertisement sentence is used during a transaction.

In accordance with the exemplary embodiments and the modifications, the transaction target is an item. The technique of the disclosure is not limited to the item, and may be applicable to a service.

Data processing in the exemplary embodiments has been described as an example. Within the scope of the disclosure, a step may be deleted, a new step may be included, or the order of steps may be reversed.

In accordance with the exemplary embodiments, data processing is performed by a software configuration using a computer. The technique of the disclosure is not limited to this method. For example, instead of the software configuration using the computer, the data processing may be performed by only a hardware configuration including a field-programmable gate array (FPGA) or an application specific integrated circuit (ASIC). Alternatively, part of the data processing is performed by the software configuration and the remaining data processing may be performed by the hardware configuration.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a predicting unit that predicts a first transaction count by which a user performs a commercial transaction of an item when an advertisement explaining the item is displayed and a second transaction count by which the user performs the commercial transaction of the item when the advertisement is not displayed;
a determination unit that determines a degree of influence that the advertisement has on the commercial transaction of the item from information on the first transaction count and the second transaction count and information on the item;
an identifying unit that identifies a combination of an item and an advertisement, the combination having a maximum degree of influence; and
a controller that performs control to display the identified combination of the item and the advertisement.

2. The information processing apparatus according to claim 1, wherein the predicting unit indicates the first transaction count by which the user performs the commercial transaction on the item when an advertisement other than an advertisement used in a past commercial transaction of the item is displayed.

3. The information processing apparatus according to claim 1, wherein the advertisement is not displayed for the item during a past commercial transaction.

4. The information processing apparatus according to claim 3, wherein the predicting unit predicts a transaction count of the item when a cluster of advertisements not displayed in the past is used.

5. The information processing apparatus according to claim 1, wherein the predicting unit predicts the first transaction count and the second transaction count by accounting for a value of at least one article that affects the transaction count to be predicted.

6. The information processing apparatus according to claim 2, wherein the predicting unit predicts the first transaction count and the second transaction count by accounting for a value of at least one article that affects the transaction count to be predicted.

7. The information processing apparatus according to claim 3, wherein the predicting unit predicts the first transaction count and the second transaction count by accounting for a value of at least one article that affects the transaction count to be predicted.

8. The information processing apparatus according to claim 4, wherein the predicting unit predicts the first transaction count and the second transaction count by accounting for a value of at least one article that affects the transaction count to be predicted.

9. The information processing apparatus according to claim 5, wherein the value of the one article is obtained by varying a value determined during the past commercial transaction of the item.

10. The information processing apparatus according to claim 6, wherein the value of the one article is obtained by varying a value determined during the past commercial transaction of the item.

11. The information processing apparatus according to claim 7, wherein the value of the one article is obtained by varying a value determined during the past commercial transaction of the item.

12. The information processing apparatus according to claim 8, wherein the value of the one article is obtained by varying a value determined during the past commercial transaction of the item.

13. An information processing apparatus comprising:
a predicting unit that predicts a growth rate of a first transaction count by which a user performs a commercial transaction of an item when an advertisement explaining the item is displayed, with respect to a second transaction count by which the user performs the commercial transaction of the item when the advertisement is not displayed;
a determination unit that, from the predicted growth rate, determines a degree of influence that the advertisement has on the commercial transaction of the item
an identifying unit that identifies a combination of an item and an advertisement, the combination having a maximum degree of influence; and
a controller that performs control to display the identified combination of the item and the advertisement.

14. The information processing apparatus according to claim 13, further comprising:
a clustering unit that clusters the advertisements used for the commercial transaction, the advertisements being sorted into a plurality of clusters, an advertisement in one of the clusters being used for a first item in the commercial transaction;
a cluster identifying unit that identifies a cluster having no advertisement associating the first item from clustering results; and
a supplement unit that supplements an advertisement to the identified cluster,
wherein the predicting unit predicts the first transaction count of each advertisement of the first item in the clusters.

15. The information processing apparatus according to claim 14, wherein the supplement unit supplements an advertisement of a second item associated with the first item to the identified cluster.

16. The information processing apparatus according to claim 15, wherein the predicting unit predicts the first transaction count and the second transaction count in view of a status of the commercial transaction.

17. The information processing apparatus according to claim 16, wherein the predicting unit predicts the first transaction count and the second transaction count with respect to each of a plurality of types of consumers.

18. The information processing apparatus according to claim 17, further comprising an output processing unit that performs an output operation on the identified first item to a predetermined output destination via an output unit.

19. The information processing apparatus according to claim 18, wherein the output processing unit further outputs the identified advertisement to the output destination.

20. A non-transitory computer readable medium storing a program causing a computer to execute a process for processing information, the process comprising:
predicting a first transaction count by which a user performs a commercial transaction of an item when an advertisement explaining the item is displayed and a second transaction count by which the user performs the commercial transaction of the item when the advertisement is not displayed;
determining a degree of influence that the advertisement has on the commercial transaction of the item from information on the first transaction count and the second transaction count and information on the item;
identifying a combination of an item and an advertisement, the combination having a maximum degree of influence; and
performing control to display the identified combination of the item and the advertisement.
